(19) United States
(12) Patent Application Publication
(10) Pub. No.: US 2005/0125162 A1
(43) Pub. Date: Jun. 9, 2005

(54) Multi-sensor device for motorized meter and methods thereof

(76) Inventors: Kiamars Hajizadeh, Lincolnshire, IL (US); Kelly Mills, McHenry, IL (US)

Correspondence Address: Wallenstein Wagner & Rockey, Ltd.;53rd Floor, 311 S. Wacker Drive, Chicago, IL, 60606-6622, US

(21) Appl. No.: 10/727,336

(22) Filed: Dec. 3, 2003

(51) Int. Cl. G06F 19/00; G01N 31/00

(52) U.S. Cl. 702/25

(57) ABSTRACT

A disc (200) having integral therewith a plurality of electrochemical sensors (10) therein to be used with a motorized meter for rapidly detecting and quantifying concentration of analytes in a fluid sample. The disc and sensors may be produced by injection molding manufacturing methods.

### TECHNICAL FIELD

The present invention relates generally to electrochemical sensors and, more particularly, to a motorized meter and compact disc electrochemical sensors for sequential analysis of an analyte, such as glucose, in a fluid test sample, and methods of making these sensors.

### BACKGROUND OF THE INVENTION

Electrochemical sensors detect and quantify a particular analyte or property in fluid samples when used in conjunction with a meter. Typically in the form of strips, the sensors have at least two electrodes—a reference electrode and a working electrode—and in some instances, a third counter electrode, in a predetermined relationship to each other for contacting the fluid sample. A reagent may be applied to the electrodes or the inner surface of the cell that holds the sample so the reagent contacts the sample during analysis. Other materials may have a role in the analysis, such as a mediator and/or an enzyme specific for the analyte; e.g., an oxidoreductase or a dehydrogenase.

This coating of one or more substances applied to a surface of at least one of the electrodes and possibly the cell, react with the fluid sample drawn into the cell, producing changes in the electrochemical properties of the sample. Such changes typically correlate to the concentration of an analyte in the sample.

Following the application of a suitable electric current or potential across the electrodes, the sensors rely on amperometry, polarography, conductivity, potentiometry, voltametry or other techniques to effect measurable changes in the sample in contact with the electrodes. The measurements are then correlated to the concentration of the analyte of interest. In recent years, electrochemical sensors have enjoyed ever-expanding applications in diverse fields such as environmental, agricultural, and medical diagnostic analyses. For example, in the medical field, diabetics now routinely use electrochemical sensors as home medical devices for monitoring blood glucose levels.

Such sensors are taking on multiple forms. For example, they can be produced individually for individual tests or in groups, such as in cartridge form. When made individually, each sensor is packaged separately to be used separately. For each use, the user removes the sensor from the packaging, performs the necessary test and disposes the used sensor after use. A group-type sensor may hold several sensors in a cartridge or disc. The cartridge or disc is put into a machine that first registers and indexes each sensor before and during use, performs the necessary test after receiving the test fluid and produces a read-out of the results of the test.

A method and apparatus of handling multiple sensors in a glucose monitoring instrument system is disclosed in U.S. Pat. No. 5,510,266 issued to Bonner et al. A sensor magazine contains a plurality of blood glucose sensors in sensor slots. Each slot is in communication with a desiccant cavity with a desiccant material disposed thereon. Both the front and rear walls of the magazine are sealed with burst foils so the individual sensors are sealed from the outside environment. An indexing wheel moves the sensor to be used into position and causes a push rod to pierce the rear burst foil, engage one of the sensors in one of the slots and push the sensor out through the front burst foil into a testing position. Once the test is completed, the push rod advances forward to eject the used sensor from the instrument. The push rod is then retracted to a standby position awaiting a request for a next sensor.

In addition, as opposed to single use sensors, there has been several patents directed to systems employing multiple tests, sequentially or concurrently. These array configurations include U.S. Pat. No. 4,225,410 issued to Pace, discloses an integrated miniaturized array of spaced-apart electrochemical sensors supported on a common substrate. Each sensor is a complete electrochemical cell specific to only one analyte. Each sensor has a first electrode layer with a given concentrating of the analyte being measured and a second electrode layer containing a different concentration of the analyte. Collectively, the sensors can analyze a single drop of a fluid sample concurrently for many different analytes.

Other inventors have used an array configuration to optimize the sensor's detection sensitivity for the analyte. For example, in U.S. Pat. No. 5,670,031, Hintsche et al. disclose an electrochemical sensor having a single microchannel with one reference electrode and an array of interdigitated pairs of microelectrodes arranged serially in the microchannel. The thin layers of microelectrodes, formed by deposition or insertion into the substrate, are arranged in the direction of the channel. This arrangement allows simultaneous or successive measurements to be taken at different locations within the microchannel as the same molecule is repeatedly oxidized and reduced while moving through the microchannel, before it diffuses out of the range of the electrodes. The resulting amplification purportedly leads to significant improvement in detection sensitivity of a single analyte.

In U.S. Pat. No. 5,547,555 issued to Schwartz et al., an electrochemical sensor is disclosed comprising an injection-molded cartridge with at least three hollow cells in a linear array. The cartridge has an electrode assembly formed as a thin film layer by sputtering deposition or lithographic techniques. The formation of the cells and the access electrodes in a linear array simplifies production and design of the electrode assembly.

U.S. Pat. No. 4,874,500 issued to Madou et al., discloses a array sensor for detecting gases, vapors, and dissolved ionic species. The array sensor comprises a unitary substrate formed of a single material having a plurality of wells extending into the substrate. Each well has a sensing electrode and a reference electrode, and optionally a counter electrode, spaced along the bottom, electrically isolated from each other—other than via an electrolytic medium. For each electrode, the well has a passage extending through the back wall into the well and a conductor, formed by mechanical positioning metal rods, fitted into each passage in contact with the electrode. The conductor electrically communicates the electrode to adjacent the back surface of the substrate. In one embodiment, the wells are arranged linearly.

U.S. Pat. No. 5,407,554 issued to Saurer, discloses one example of an electrochemical sensor with an array of isolatable sensing areas. This reference discloses a sensor, configured as a disc and having an array of sequentially isolatable “active zones” situated along the periphery of the disc. Near the center of the disk are at least two “current collectors” of conducting material that traverse each active zone to form electrodes in these zones. Each zone is traversed by the same set of electrodes. The configuration allows a single sensor to execute several successive measurements of the same parameter. The current collectors are formed by deposition techniques or lamination.

During the manufacturing process, the electrodes must be carefully formed. The more common techniques for electrode formation include deposition of metals, screen-printing, lamination, and unrolling thin strips of metal from large rolls. Of these, screen-printing and the unrolling methods are widely used to mass produce relatively inexpensive sensors for measuring glucose.

Despite their wide use, these technologies—particularly screen printing and conductive ink production—suffer from a host of problems; e.g., poor reproducibility of the electrode surface area, dimensional variations, thickness variations, micro-cracks, and shrinkage attributable to the repetitive and high temperature curing processes used in the film printing technology. In addition, other production-related problems may lead to vast differences in the potential applied to the electrodes, lack of uniformity in the applied metals, and material waste such as loss of solvent during printing that may affect the thickness of electrodes. Because each of these factors may change the electrochemical signal readout, they may compromise the precision and accuracy of the electrochemical measurements.

Thus, there exists a need for an electrochemical sensor that offers rapid sample analysis of multiple samples and ease of production.

### SUMMARY OF THE INVENTION

The present invention is a disc housing a plurality of electrochemical sensors therein to be used with a motorized meter for rapidly detecting and quantifying concentration of analytes in a fluid sample. The disc, and integral sensors, may be produced by injection molding manufacturing methods.

The technology incorporated in the present invention extends from that disclosed in U.S. Pat. Nos. 6,572,745 and 6,576,102, assigned to the owner of the present invention, Virotek LLC, Buffalo Grove, Ill.

To that end, in one aspect of the invention generally, a disc is disclosed with a plurality of separate, yet integral and unitary, electrochemical sensors constructed therein. Used in conjunction with a motorized meter, the disc can be used to perform sequential tests for detecting or quantifying analytes in a fluid sample.

Each integral sensor molded simultaneously and carried by the disc includes a molded body of insulative material having a first end and a second end, a cavity, and an inlet leading to the cavity for receiving the test fluid into the cavity. In the body, between the two ends, are at least two electrodes in fixed longitudinal relation to each other. The electrodes, electrically insulated from each other, are at least in communications with one another when a fluid is received in the cavity. Electrically downstream of the cavity, the electrodes are at least partially exposed so that an electronic reading can be made by an outside meter of an electrical property resulting from the electrochemical communication of the electrodes with the fluid.

The electrodes comprise a working electrode and a reference electrode, and may, if desired, further include a counter electrode.

The plurality of sensors are positioned in an array so the inlets are radially separated, by along or adjacent the periphery of the disc.

Specifically, the present electrochemical device is a carrier of molded insulative material. This carrier is in disc form and supports a plurality of electronic sensors therein. The sensors are built, or molded, directly into the carrier. The sensors radially spoke outwardly from a central area of the disc and are spaced radially apart from one another. Each projects to a location adjacent the disc's perimeter. In one embodiment, the sensors extend beyond the perimeter and stick out from the disc. In another embodiment, the sensor's length is less than the radius of the disc.

Each sensor has at least two spaced apart electrically conductive electrodes with at least a portion thereof embedded in the insulative material and/or a portion thereof encased within the insulative material. Each sensor further has a contact area at an inner end thereof for contacting and communicating with a meter when the sensor is in use. An inlet capillary at the distal end of each sensor receives the fluid and moves it to an internal reaction zone. In the figures shown, the plurality of inlets are along or adjacent a periphery of the disc. Specifically, the inlet is configured such that when a user contacts the end of the sensor with the inlet, the fluid is drawn into the sensor. The inlet is formed in the end of each sensor by a cap that covers each molded sensors. Such caps can be molded with the sensor and folded about a hinge to form the inlet end of the sensor. The caps can also be molded separately from the disc and sensors and attached to the inlet end of the each sensor.

One or more substances are on one or more of the electrodes to change the electrical properties between the electrodes upon reacting with the fluid sample. As a result, a meter can measure the electrical properties (and changes) between electrodes before, during and after a test with a fluid sample drawn into the sensor.

As noted, the electrodes are substantially molded into the insulative material of the carrier. The sensors are preferably fixed within the carrier and not removable from the carrier. In the preferred embodiment, the carrier is a substantially circular disc. As a result, a meter used in conjunction with the disc rotates the disc to expose or access one sensor at a time. The electrodes are one of either conductive wires or formed from a conductive plate. The electrodes formed from a conductive plate are stamped in a desired configuration or pattern. With either the wired or plate electrodes, one or more may also be coated with a conductive material different than the composition of the electrode.

As with U.S. Pat. Nos. 6,572,745 and 6,576,102, incorporated herein by reference, means for detecting when a sufficient amount of the fluid sample has been received by the sensor can be further incorporate in each sensor. Such means can be an electrical indication or a visual indication. Such means can include a depressurization vent formed in the body, in communication with a reaction zone, and allowing for fill detection to be made visually. The detection means can also be a reaction zone and electrode arrangement configured to activate the meter when fluid has passed over two or more electrodes thereby closing a circuit.

According to another aspect of the present invention, a method is disclosed for making the testing device capable of carrying a plurality of sensors and testing a plurality of fluid samples. First, if the electrodes for the device are conductive wires, they are pulled into a mold for a carrier. In the alternative, the electrodes are formed by stamping out a specific pattern from an electrically conductive plate. These electrodes (wire or stamped) are then positioning in at least pairs (sometimes triples) grouped to form individual sensors and spaced apart in the mold for the carrier. The carrier is then molded using insulative material to at least embed and encase portions of the electrodes in the insulative material. Each grouping of electrodes is a stand-alone sensor. One or more electrodes in each grouping (pairs or triples) are positioned within the mold such that it/they can be exposed to a fluid sample to be tested. One or more electrodes in each grouping is treated with one or more substances before or after the molding of the carrier for reacting with the fluid sample to be tested.

During molding, the electrodes are held in place. Specifically, the electrically conductive electrodes are substantially molded into the insulative material with at least a part thereof embedded within the insulative material in fixed longitudinal relation in the insulative material.

After molding, any unnecessary internal connections are cut by the retracting mold portions. Next, the end of each grouping forming an independent sensor is formed. The end cap is formed by pivoting a portion or extension of insulating material adjacent each grouping about a hinge onto the grouping or by attaching a separate piece onto the carrier above each grouping. Each grouping or sensor formed in the disc includes a capillary inlet formed in the carrier in communication with a reaction zone and a vent.

### BRIEF DESCRIPTION OF THE DRAWINGS

In the accompanying drawings forming part of the specification, and in which like numerals are employed to designate like parts throughout the same,

FIG. 1 is a schematic view of one embodiment of a disc supporting a plurality of electrochemical sensors made in accordance with the teachings of the present invention;

FIG. 2 is a sectional view along line 2-2 of FIG. 1;

FIG. 3 is a schematic view of an individual sensor within the disc;

FIGS. 4A and 4B are schematic views of the electrode configuration for the molding process;

FIG. 5 is an enlarged schematic view of a portion of the configuration shown in FIGS. 4A and 4B;

FIG. 6 is a schematic view of the disc of FIG. 1 showing the layout and placement of the covers and exposed areas of the electrodes;

FIG. 7 is a sectional view along line 7-7 in FIG. 6;

FIG. 8 is a detail of the keyed hole in the center of the disc;

FIG. 9 is a sectional view of a ball contact in the meter;

FIG. 10 is a further schematic view of the disc of FIG. 1 showing an alternate layout and placement of the covers and exposed areas of the electrodes; and,

FIG. 11, like FIG. 5, is an enlarged schematic view of a portion of the configuration shown in FIGS. 4A and 4B, just after stamping the desired pattern.

### DETAILED DESCRIPTION

While this invention is susceptible of embodiments in many different forms, there is shown in the drawings and will herein be described in detail preferred embodiments of the invention with the understanding the present disclosure is to be considered as an exemplification of the principles of the invention and is not intended to limit the broad aspect of the invention to the embodiments illustrated.

The Disc and Sensors Therein

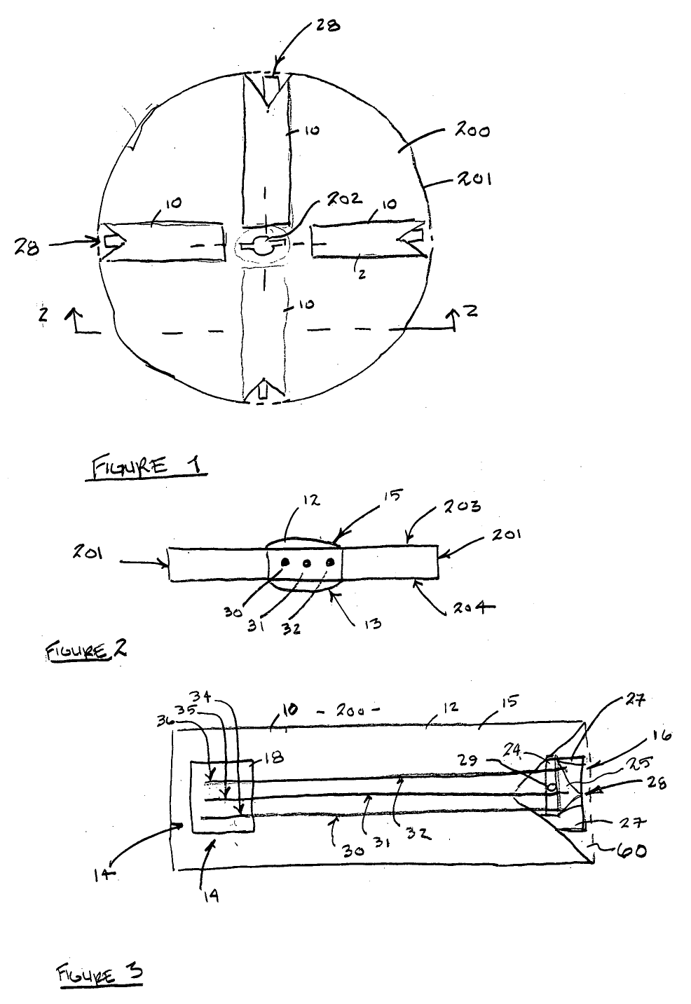

The present invention provides a carrier in the form of a rotatable disk, generally designated by reference 200, having a plurality of electrochemical sensors 10 therein for detecting and quantifying analytes in a fluid sample. The sensors are unitary or integral with the disc, ideally all (the sensors and disc) being molded as a single piece, typically of molded plastic (injection molding). The carrier 200 is composed of a molded body of an insulative material, having an outer perimeter 201 and a center 202, along with a top surface 203 and a bottom surface 204. Disposed within the disc 200 are a plurality of individual, radially spaced apart and spoking, electrochemical sensors 10. As to each such sensor 10, reference can be to U.S. Pat. Nos. 6,572,745 and 6,576,102, incorporated herein by reference. FIG. 1 shows four (4) such sensors 10 incorporated in the carrier disc 200. It is appreciated that several more sensors can be radially spaced apart on the disc, along with a calibrating sensor applicable to all of the sensors on a disc, e.g., 8, 12, 16, 20, 24 sensors per disc.

Generally, each sensor is a complete (stand-alone) electrochemical sensor and may be a two or three lead, or electrode system. With reference to the Figures, wherein a three electrode 30,31,32 system is shown, each spoking sensor 10 (for illustrative purposes, the disc is assumed made of clear plastic, permitting one to look inside it) includes a body 12, preferably unitary and integral with the disc 200 that is opaque or translucent, with a meter reading end 14 and a fluid sample receiving end 16.

The body has a bottom surface 13 and a top surface 15 flush with or bulged from the top and bottom surfaces 203,204 of the disc 200 (FIG. 2). The meter reading end 14 of the body 12 includes one or more openings 18 in the top surface 15 so that a meter may read the exposed electrodes 30,31,32 by physically contacting them.

The fluid sample receiving end 16 of each of the sensors 10 includes an inlet 28 and an electrochemical reaction zone or cavity 24, an internal channel formed about/adjacent the electrodes 30,31,32 in the body 12 for detecting and analyzing the fluid drawn into the body 12 for a particular analyte. A further channel 25 connects the cavity 24 to the inlet 28.

As seen in FIG. 1, the array is arranged such that the capillary inlets 28 are positioned along and adjacent the periphery of the disc 200.

It should be noted that while the inlet 28 is shown as a capillary inlet, such an inlet can take on many forms. These other inlets are well known to those in the filed and include, a touch-zone, wherein an individual places the blood on the top or bottom of the sensor in a particular area so that the blood can be collected and/or absorbed (with or without absorbent material) and transported to a reaction area.

While the reaction zone may be formed above or below the electrodes, the preference has been to construct it above the electrodes. In the reaction zone 24 the leads are not entirely encased by the insulative material of the body; at least a portion of the leads—e.g., the tips, sides, or other portion—is exposed therein as sensing electrodes 30,31,32 for contacting the fluid sample drawn into the body 12 through the capillary inlet 28 and channel 25 of the sensor 10 through the inlet 28.

An end cap 27 is attached by ultrasonic welding or adhesives over the reaction zone 24 and onto the electrodes to cover the electrodes, but maintains the integrity of the reaction zone 24. Indeed, a channel in the cap 27 enhances flow into and forms part of the reaction zone 24. The reaction zone has a volume defined by the shape of the channel within the body and end cap.

This end cap 27 is preferably made of the same material as the molded body 12 of the sensors 10 and disc 200.

The end cap 27 can be a separate piece or constructed as part of the body 12 and hingeably connected to the body (e.g., a recessed portion on the top surface 15 of the body) such that it can be pivoted onto the electrodes and reaction zone. In this manner, the entire sensor can be made at one time and as one molded, unitary piece. Attention is drawn to U.S. Pat. Nos. 6,572,745 and 6,576,102 showing such features and incorporated herein by reference.

A capillary opening 28 is formed in the terminal end 16 of the sensor 10 when the cap 27 is welded (or folded) to the body 12 or pivoted about a hinge onto a recessed portion of the body. This capillary opening leads to the reaction zone 24. Preferably, the sensor 10 is a capillary fill device, that is, the inlet 28 and reaction zone 24 are small enough to draw a fluid sample into the zone when the capillary opening or inlet 28 is placed in contact with the fluid being tested, such as a drop of blood. Accordingly, if one wants to test his/her blood, s/he touches the terminal end 16 to the blood and the blood is drawn into the sensor 10 and reaction zone 24 through the capillary opening 28. This is much easier than placing the sample (such as blood) on the sensor and on a target zone as in the prior art.

To effectuate the capillary effect with the capillary opening 28 to the reaction zone 24, a vent 29 is constructed into the cap 27. This vent is in communication with the reaction zone 24. This vent 29 releases air pressure as the reaction zone 24 draws and fills with fluid. For additional discussion regarding capillary filling, see U.S. Pat. Nos. 4,254,083; 4,413,407; 4,473,457; 5,798,031; 5,120,420; 5,575,895; 6,572,745; and, 6,576,102, the disclosures of which are hereby incorporated by reference.

Mostly encased within the injection molded body 12 and disc 200 are a plurality of electrically conductive leads or electrodes 30,31,32. Preferably, the bodies 12, and disc 200 itself, are molded about these leads 30,31,32. As noted, these individual leads in each body 12 are spaced and insulated from one another. They 30,31,32 are primarily encased in the body 12 running generally longitudinally and spaced apart (and electronically insulated from one another) from the reading end 14 to the reaction zone 24, to just before the terminal end 16. The leads' 30,31,32 ends 26 are positioned just before the terminal end 16 of each sensor.

The conductive leads 30,31,32 are wires or plates, and consist of an electrically conductive material like metal or metal alloy such as platinum, palladium, gold, silver, nickel, nickel-chrome, nickel-palladium, stainless steel, copper or the like. Moreover, each lead preferably consists of a single wire, or in an alternative preferred embodiment, a stamped metal member plated with gold or the like. In the embodiment shown, the outer leads 30 and 32 are equally spaced from the inner lead 31 with the spacing of the leads at the fluid sample receiving end 16 of the body 12 being closer together than at the meter reading end 14.

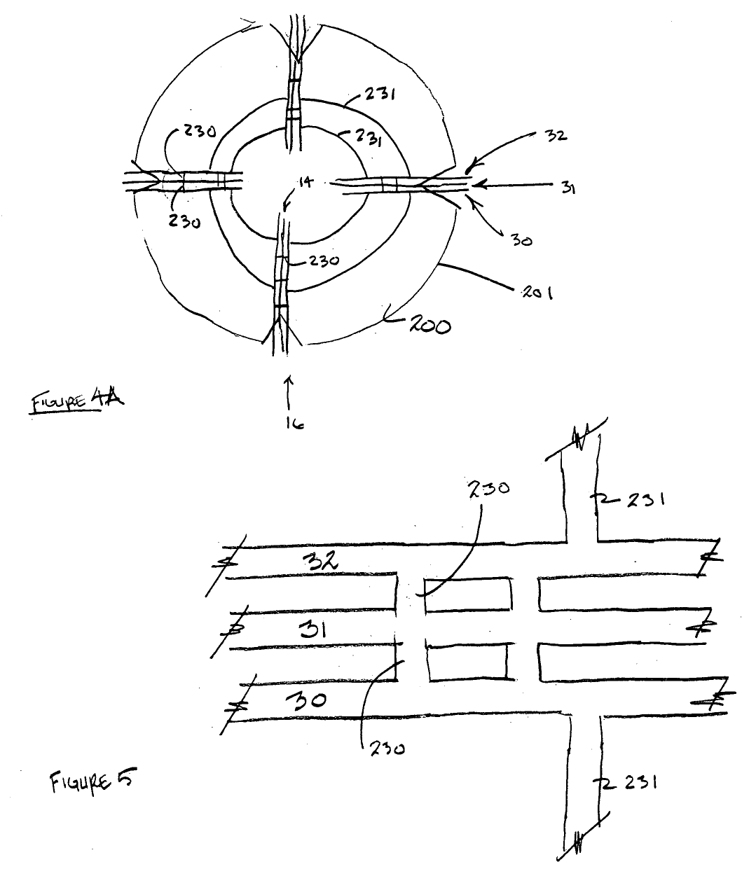

A conductive plate is stamped by conventional means into a particular pattern; the desired stamped pattern includes the leads 30,31,32 and the connecting segments 230 and 231 (FIGS. 4A and 4B) and/or radially spoking segments 232 (FIG. 4B). The conductive plate can be formed in its desired configuration or pattern or stamped from a larger conductive plate. After the sensor is molded, the segments 230 and 231 in FIG. 4A and 4B interconnecting the leads and sensors and any radial holding portions, segments 232 in FIG. 4B are cut and/or removed to electrically separate the leads and the sensors from one another. When stamped plates are used, the leads may be widened if desired in the reaction zone to expose more surface area to the fluid and chemicals contacting one another in the zone. In addition, the leads can be made narrower or miniaturized. The leads can be as wide as the sensing parts. In addition, stamping the desired conductor pattern from a conductive plate gives one flexibility in configuring the size, shape and path of each lead so as to maximize efficiency and reduce costs.

The opening(s) 18 in the body 12 exposes the leads 30,31,32 adjacent the reading end 14 of the body 12 to provide one or more electrical contacts, that being specific contact surface areas 34,35,36 where the electrodes are exposed for electrically communicating with a meter (not shown). This opening may be a single opening exposing all of the electrodes or multiple openings, each opening exposing a single electrode. As noted, the electrodes 30,31,32 are molded into the body 12 of the electrode and into the disc. They 30,31,32 are preferably encased or encircled upstream and downstream of the opening(s) 18 and preferably, embedded in the area with the opening(s) 18. In short, preferably, while the top surfaces of the contact surface areas 34,35,36 are exposed, the electrodes remain at least partially embodied in the body at such location. Specifically, the body 12 may be molded such that the segments 33 of the leads 31,31,32 are embedded and held by the body 12 opposite the contact surface areas 34,35,36. In this manner, the leads are exposed for contact with the meter and maintained in a position without the use of adhesives or welding.

The portion of the leads 30,31,32 between the sensor reading end 14 and the fluid sample receiving end 16 are embedded or encased within the plastic injection molded body 12. Accordingly, the body 12, as well as the disc 200, is constructed of an electrically insulating injection moldable plastic.

Certain structural support components may be formed in the body 12 of each sensor 10 to hold and maintain the leads 30, 31, 32 within the body, in spaced relationship to one another, during and after the molding process. Though not shown, guide blocks and alignment pins may be molded within the body 12 for proper mounting of the leads 30,31,32. Apertures (not shown) are also formed in the top surface 15 and bottom surface 13 of the body 12 for permitting the ingress and egress of fingers into the mold during the molding process (to be discussed below). For further details regarding the molding process, attention should be drawn to U.S. Pat. Nos. 6,572,745 and 6,576,102. Once the molding is completed, each of the apertures is covered up or sealed with plastic (e.g., the same plastic used in the molding process) or left open. Such apertures are relatively small; leaving them open should not cause any safety issues or affect the sensor's ability. Fingers cannot fit into the apertures and debris from the outside will likely be unable to enter the apertures and contact the leads 30,31,32.

FIGS. 4A and 4B show the electrode configuration before molding.

Within the reaction zone 24, one lead 30 serves as a primary working electrode, a second lead 31 acts as a reference or counter electrode, and the third lead 32 serves as an auxiliary, secondary or second working electrode. Desirably, the conductive leads 30,31,32, or electrodes are the only leads (electrodes) coming into contact with the test sample of fluid entering the sensor 10. The electrodes are electrically insulated from the rest of the sensor 10 and the other sensors in the disc 200 by molded plastic to ensure a signal carried by the leads arises only from that portion exposed to the test sample in the electrochemical reaction zone 24.

An enzyme, conjugated to another moiety, such as an antibody or antigen or an analyte, is applied to the outer surface of the primary working electrode 30, and if desired, an electron transfer mediator may be applied to the same electrode 32. An antibody may also be applied to the outer surface of the secondary working electrode or otherwise present in the reaction zone. As such, the reaction zone can contain antibodies, enzyme-antibody conjugates, enzyme-analyte conjugates, and the like.

The enzyme can consist of, for instance, flavo-proteins, pqq-enzymes, haem-containing enzymes, oxidoreductase, or the like. For additional discussion regarding mediators, see U.S. Pat. Nos. 4,545,382 and 4,224,125, the disclosures of which are hereby incorporated by reference. In an alternative embodiment, an antibody can be applied to the outer surface of the secondary working electrode 32. As such, the reaction zone 24 can contain antibodies, enzyme-antibody conjugates, enzyme-analyte conjugates, and the like. It should be noted that an enzyme can also be applied to the second working electrode and an antibody can be applied to the outer surface of the primary working electrode.

As will be appreciated by those having skill in the art, the enzyme is specific for the test to be performed by the sensor 10. For instance, the working electrode, or secondary working electrode, or both, can be coated with an enzyme such as glucose oxidase or glucose dehydrogenase formulated to react at different levels or intensities for the measurement of glucose in a human blood sample. Thus, as an individual's body glucose concentration increases, the enzyme will make more products. The glucose sensor is used with a meter to measure the electrochemical signal, such as electrical current, arising from oxidation or reduction of the enzymatic turnover product(s). The magnitude of the signal is directly proportional to the glucose concentration or any other compound for which a specific enzyme has been coated on the electrodes.

In addition to the above, the enzyme can be applied to the entire exposed surface area of the primary electrode (or secondary electrode). Alternatively, the entire exposed area of the electrode may not need to be covered with the enzyme as long as a well defined area of the electrode is covered with the enzyme. Further, and as shown in the prior art, an enzyme can be applied to all the electrodes 30,31,32 in the reaction zone 24 and measures can be taken by a meter.

In yet another aspect, the reaction zone or cavity 24 may itself be coated with a substance—such as a reagent, an antibody, or an enzyme—that reacts with certain constituents in the fluid sample to change the electrochemical properties of the sample. The resulting change is readily detected by the electrodes and measured by the meter.

In the preferred embodiment, one of the working electrodes is selectively coated with the enzyme carrying a reagent with the enzyme and the other working electrode is coated with a reagent lacking the respective enzyme. As such, with a meter, one can simultaneously acquire an electrochemical signal from each working electrode and correct for any “background noise” arising from a sample matrix. Thus, the potential, voltage, resistance or current between the reference and the electrode without the enzyme can be compared with the potential, voltage, resistance or current between the reference and the electrode with the enzyme. The measuring and comparing of the potential, voltage, resistance and current differences are well known to those skilled in the art.

As indicated above, the sensor 10 is used in conjunction with a meter capable of measuring an electrical property of the fluid sample after the addition of the fluid sample into the reaction zone 24. The electrical property being measured may be, for example, electrical current, electrical potential, electrical charge, or impedance.

In addition to the above, for each sensor, fill detection, visual or electrical, can also be employed. A depressurization vent (not shown) may be added to the cap a back wall (or downstream) of the reaction zone (farthest from the terminal end 16) for providing visual confirmation of fill detection. As sample fluid enters the reaction zone, it thus travels toward the end of the reaction zone farthest from the capillary inlet until it reaches the depressurization vent. One can visually determine if enough fluid has been introduced into the sensor. In addition, the fluid contacts at least two properly positioned electrodes, causing a circuit to close. As such, a current through the electrodes will be detectable, showing the reaction zone is sufficiently filled with fluid.

Many analyte-containing fluids can be analyzed by the electrochemical sensor of the present invention. For example, analytes in human and animal body fluids, such as whole blood, blood serum and plasma, urine and cerebrospinal fluid may all be measured. Also, analytes found in fermentation products, food and agricultural products, and in environmental substances, which potentially contain environmental contaminants, may be measured.

The individual sensors 10 have a length of approximately 1.5 to 2 cm. The diameter of the disc 200 is about 3 to 5 cm.

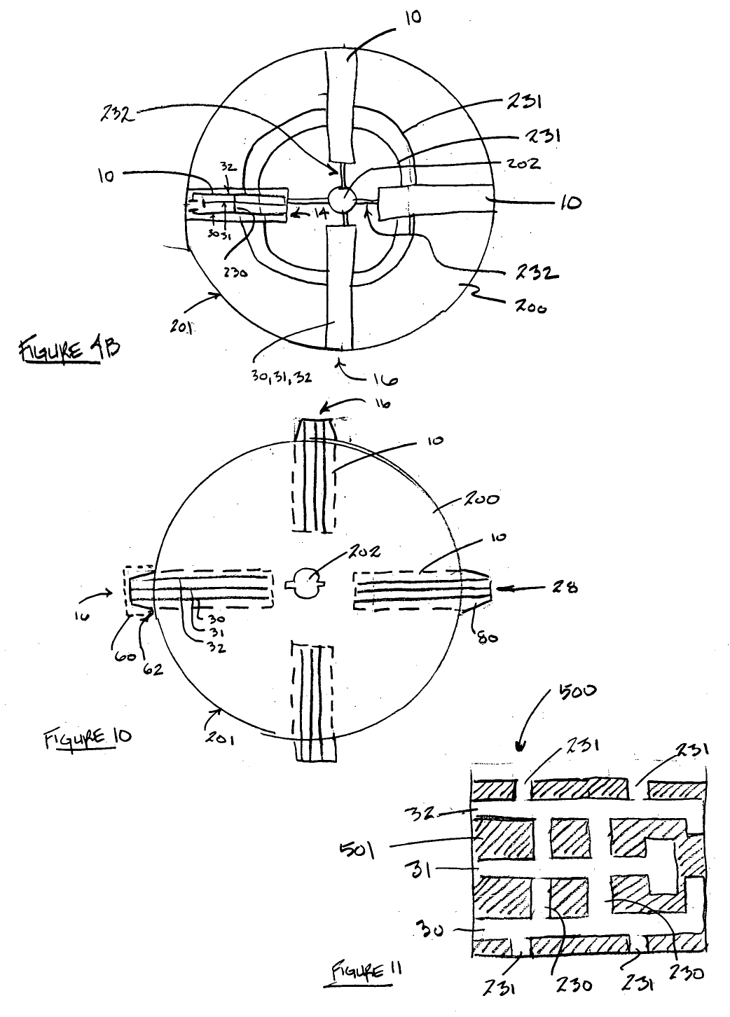

While the disc 200 is packaged in a sanitary sealed package (e.g., foil), the individual sensors are preferably also covered, or protected, before use, to prevent contamination and to keep moisture from entering the reaction zone and possibly affecting the stability of the chemistry within the sensor. Sealed, the sensor stays inactive until desired to be activated. A protective cover 60 is employed for this purpose. When constructed, the disc 200 includes notches (here shown as V-shaped notches 250) formed by notch edges 251 with the distal end 16 of each sensor projecting radially outwardly, within the notches between the notch edges (FIG. 6). A separate cover 60 is configured to seat against the notch 250. In particular, the cover's 60 edges 62 abut the notch edges 251. An internal channel 65 within the cover 60 seats the distal end 16 of the sensor 10 (FIGS. 6 and 7).

The cover 60 may also be made of injection molded plastic, though it may be softer, and/or have a higher coefficient of friction than the disc 200. As a result, a user can pinch the outer surface 61 of the cover 60 and pull it radially away from the disc to expose the distal end 16 and capillary inlet 28 of the sensor 10. After testing, the cover can be placed back on the sensor or discarded. In an effort to reduce litter, the meter can house a chamber to store discarded covers until disposal of the disc.

The cover 60 may also be removed automatically and mechanically within the meter, such as by or through a mechanical action, e.g., a moving lever that ejects the cover out of the meter. It should be noted that the disc, when stored on the shelf must be kept in a sealed (aluminum) wrap. The wrap is removed and the disc is placed in the meter to begin testing. The disc has a limited shelf life once unsealed and placed into the meter. While not shown, it is recognized that the cover can also be incorporated into the meter, as an option.

In the alternative, the cover 60 may take other forms, such as a peelable skin or wrapping, that can cover and selectively expose the distal end of the sensor with the inlet.

In the preferred embodiment, the notch 250 matches, but is smaller than a similarly contoured opening in the meter. Specifically, the disc fits into a meter that includes a housing to hold the disc, a motor and drive mechanism, an indexing system, a testing mechanism for testing the electrochemical properties of the electrodes in the sensor, testing software, a read-out of the test's results and a counter displaying the number of unused sensors remaining on the disc or, in the alternative, the number of used sensors on the disc.

In an alternative embodiment shown schematically in FIG. 10, a notch 60 is not employed. The individual sensors 10 radially spoke within the disc, but at the distal end 16 thereof, project outwardly slightly (segment 80) from the disc's perimeter 201. As with the prior embodiment, a cover 82 may be employed over the projecting segment 80. The cover's edges 62 generally abut the perimeter 201 of the disc.

As before, the cover 60 may be made of injection molded plastic, though it may be softer, and/or have a higher coefficient of friction than the disc 200. As a result, a user can pinch this outer surface 61 of the cover 60 and pull it radially away from the disc to expose the distal end 16 and capillary inlet 28 of the sensor 10. After testing, the cover can be placed back on the sensor or discarded. In an effort to reduce litter, the meter can house a chamber to store discarded covers until disposal of the disc.

The cover 60 may also be removed automatically and mechanically within the meter and be a peelable skin as discussed above.

The meter's motor is connected to a drive mechanism, such as a contoured (keyed) drive spindle. Proper insertion of the disc into the meter requires the disc to properly seated within the meter and to mate with the centrally located drive spindle. The drive spindle and keyed opening in the center of the disc ensure the disc can be oriented one way only. In particular, the center of the disc 200 is keyed 70 to fit over and around a similarly keyed spindle (not shown). As shown in FIG. 8, the keyed centered hole 70 in the disc 200 is designed to ensure proper seating of the disc in the meter. The hole 70 includes a central circular portion 71 and three legs 72,73,74. The opposed legs 73,74 have different lengths. The hole 70 is asymmetrical. Consequently, the disc must be oriented in a specific direction and position to fit over the similarly contoured spindle to seat properly. Only one position (and facing only one direction) will match the configuration of the spindle, ensuring proper seating.

The openings 18 in the sensor's housing for exposing the electrodes to the meter were discussed above. In the preferred embodiment, the body 12 has a plurality of openings 18 for exposing the leads 30,31,32 adjacent the reading end 14 of the body 12 to provide contact surface areas 34,35,36 respectively for the meter. These contact areas 34,35,36 need not be large. As shown in FIG. 6, such contact areas 34,35,36 can be dots, or circular sections, of exposed leads, in the openings 18 top surface 15 of each sensor 10. By exposing the leads 34,35,36, recesses are naturally formed in the top surface 15 of the sensor 10. The meter, in turn, is equipped with spring loaded electrical contacts.

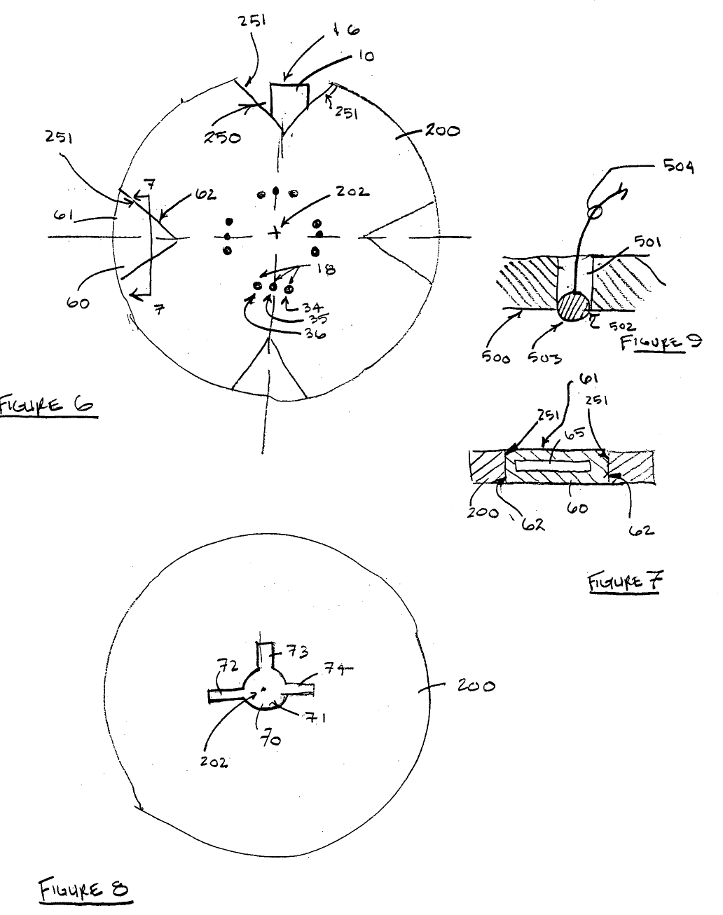

By way of example, FIG. 9 shows an inner wall 500 of the meter with a transverse passageway 501 and passageway lip 502. An electrically conductive ball 503 with an electronic connection thereto 504 is seated in the passageway 501. The lip 502 prevents the ball 503 from passing out of the passageway and a spring (not shown) in the passageway urges the ball against the lip. The ball 503 is thus “spring loaded and will raise and lower depending on the surface passing against it. As a result, the balls 503 (three in the meter to mirror the number of electrodes in each strip) are urged by the spring and contact the exposed leads 34,35,36 when the exposed portions of the leads (and recesses and openings in the top surface of the sensor) are indexed and aligned directly below the balls to make an electrical connection between the meter and the sensor being used for testing. The ball contacts 503 will not interfere with the disc 200 rotating about the spindle in the meter.

Because the sensors are not individually packaged, a desiccant material molded into the caps and/or covers of the sensors, on the sensors or/or on the sensor disc. In addition, the sensor must be covered (manually or automatically) when the meter is turned off. As such, the meter is fitted with a cover, to protect and cover the opening mentioned previously, when the meter is not in use. In addition, rubber blinds, or seals, may be fitted adjacent the meter opening and against the disc to ensure contaminants and moisture (humidity) do not get into the meter or onto/into the sensors during use or when the opening is exposed. The disc travels between such seals.

In addition to protecting against contaminants, another important consideration is blood. It is important that excess blood—that is blood not flowing into an individual sensor—does not jeopardize and affect the meter or other sensors forming part of the disc. Constructing the meter's opening/gap with a seal or wiper adjacent to it to wipe or clean the rotating disc may be necessary. In the alternative, the opening/gap can be sized, or have provisions (e.g., absorbent pad therein) to permit the excess blood to dry before rotating into the meter. The disc itself can also have the sensors spaced so as to permit blood to dry before flowing near another sensor on the disc. Finally, the disc can be constructed (or assembled) with an absorbent element adjacent or between individual sensors in order to catch and hold any excess blood.

Ideally, one sensor on the disc is for calibration purposes only. Accordingly, when a new disc is properly oriented and placed into the meter, the meter is either manually or automatically activated. Proper insertion of the disc requires the disc to properly seat within the meter and mate with the centrally located drive shaft. The drive shaft and keyed opening in the center of the disc ensure the disc can be oriented one way only.

The meter either starts at a home position due to orientation when inserting the disc or indexes to a home position and the calibration sensor. Once the meter is at the calibration sensor, it next performs the necessary calibration test which calibrates the meter for the entire disc, that is all of the sensors integral with the disc in the meter. Such calibration techniques are well known to those skilled in the art.

When one desires to perform a test, s/he activates the meter which in response rotates (by the internal motor, such as a stepping motor or continuous motion motor) the disc and indexes the disc so that the next available unused sensor is projecting in a meter opening—sized so as to make the end of the sensor easily accessible. The user removes the exposed protective cover for the unused sensor and introduces the fluid to be tested. For a glucose test, an individual puts a drop or so of blood (from a puncture) against the distal end of the sensor and capillary inlet. The blood is then drawn into the sensor and reaction zone. If a fill detector is incorporated with the sensor, the individual can determine visually or electronically if the amount of blood introduced into the sensor is sufficient to perform the required test(s).

The testing mechanism for testing the electrochemical properties (e.g., the potential, voltage, resistance or current between the reference and the electrode without the enzyme are generally compared to the potential, voltage, resistance or current between the reference and the electrode with the enzyme) is engaged and the requisite test(s) is performed.

The software analyzes the test(s) and a read-out displays the test results. The results may also be stored in the meter or transmitted to a separate device. The meter may also give an indication, e.g., a light (diode) or displayed statement, that the test is completed.

The device is then turned-off or a second test, with a new, unused sensor on the disc performed as described above. When the meter is turned-off, the used disc is either rotated so that a sensor, or a sensor's protective cover is not projecting into the meter's opening or left in the opening until the next test. A meter cap may then be pivoted or slid over the opening to prevent any contaminants from inadvertently entering the meter or opening.

Each time the disc is rotated, a counter displays the number of unused sensors remaining on the disc or, in the alternative, the number of used sensors on the disc. Such displays may be a lensed window in the meter permitting viewing of printings on the disc corresponding to the used or unused sensors. Or, such a display may involve a mechanical or electrical counter within the meter reading mechanical or electrical properties of the rotating disc.

Once all of the sensors on a disc have been used, the meter will indicate the disk is used up on the display, and then the disc may be properly discarded by ejecting it from the meter.

The Molding Process

In the past, while recognized for its strength and durability, plastic injection molding of sensors has been difficult and thus avoided. One reason is the reluctance to mold around conductive wires or conductive plates. The industry choice has been to make such sensors like sandwiches, having a top and bottom piece with the insides (conductive elements) being formed on one of the pieces or placed between the pieces. The sandwich-like sensor is then assembled together and sealed closed, such as with an adhesive.

The present invention molds the disc and sensors with the conductive elements inside the mold during the molding process. The advantages are many. In addition to making a stronger more durable sensor, such a process reduces labor involvement and steps and produces a more consistent product. While multiple discs can be produced with one mold, the making of a single disc sensor will be discussed.

If the leads are wired, they are first pulled and positioned in the molds. If the leads are stamped they are first cut. For example, as shown in FIG. 11, a metal plate 500 of the chosen conductive material is stamped to cut-out the desired electrode shape. Only a small portion of the plate 500 is shown in FIG. 11. Here, the unused material 501 from the metal plate 500 is recycled. The stamped-out electrodes are then positioned and put into the mold.

Before placing in the mold, the conductive leads/electrodes are first treated or coated with any metal/conductive coatings, if desired.

Either before going into the mold or immediately after going into the mold, the chemicals/reagents (e.g., antibody, reagent, with and without enzymes, etc.) are applied to the electrodes/leads. One, however, must be mindful that proteins will decompose at typical molding temperatures.

The mold generally has the shape of the disc 200. The conductive leads (wires or stamped conductive plates) for the electrodes are molded into the disc as follows—Feeding machines (not shown) may be radially spaced around the mold (and disc) and the leads may be radially fed into the mold before molding. In the alternative, the leads may be manually or automatically placed on or between fingers (not shown) projecting into the mold through openings in the mold (corresponding to apertures in either the sensors themselves or the disc) to hold the wires in place and level during the set-up and molding process. In particular, apertures permit mechanical fingers projecting into bottom of the mold to support the leads and projecting into the top of the mold to hold the leads. Knives or punches (not shown) are also inserted through the top surface of the mold. These knives punch and sever the joining extensions 230,231,232 and hold the bent portions in place during molding.

The liquid plastic is injected into the mold where it fills the mold. The plastic is then cooled. As shown in FIGS. 4A and 4B, the leads may be interconnected, both between the individual leads within a sensor (segments 230) and between individual sensors (segments 231) (FIG. 5). The leads may also be held in place during stamping (of the conductive metal), set-up and molding, by radial segments 232 (FIG. 4B).

Once the plastic has formed and hardened, the fingers are pulled from and exit the mold through openings (apertures). In conjunction with the removal of the fingers, separate knives/punches are drawn through the upper surface and removed; as they are withdrawn, they cut or skive extensions or portions 230,231,232 disposed between the leads and sensors and/or radially to each sensor ensuring the leads are distinct and separate from one another and the individual sensors are distinct and separate from one another. If the leads or sensors were connected, the system would in all likelihood short circuit.

The molded disc is next ejected from the mold.

If not applied before molding, the chemicals/reagents (including the enzyme) are next applied to the electrodes. Preferably, the critical reagents are applied to the sensors in the reaction zones 24 above the leads. A surfactant can be used to treat the capillary inlet to facilitate the capillary function. Any extraneous metal or plastic burrs projecting from the discs can be cut and removed.

After molding is finished, the cap may also be treated with a surfactant that facilitates pulling or drawing the fluid (e.g., test blood) into the capillary gap at the end of the sensor.

The end caps are thereafter attached (connected as a separate piece or rotated and folded about a hinge) to the main bodies of each sensor 12 and any undesirable openings in the sensors or discs can be sealed closed by the same plastic used for the mold. In the alternative, the chemicals can be applied to the leads after the end caps are married to the bodies. Any extraneous wire(s) projecting from the sensor can be cut and removed. Then, any desired writings on the sensors (e.g., manufacturing codes, product name, etc.) can then be applied to the disc by conventional means.

It should be noted that the disc sensor and method for making it described above focus on the components and construction of a three electrode/lead sensor. The teachings apply equally to devices and methods employing only two electrodes or more than three electrodes. Using two, as opposed to three electrodes, in an electrochemical sensor to rapidly detect and quantify a concentration of analytes in a fluid sample is well known and understood in the art.

While the specific embodiments have been illustrated and described, numerous modifications come to mind without significantly departing from the spirit of the invention and the scope of protection is only limited by the scope of the accompanying claims. For instance, in another embodiment of the present invention, a sensor is designed for use with a light reflectance measuring meter for photometric detection of a dye contained within a fluid sample receiving well.

1. An electrochemical device for cooperating with an electronic meter capable of holding the device, moving the device and measuring electrical properties between at least two electrically conductive electrodes, comprising:
a carrier of molded insulative material supporting a plurality of electronic sensors thereon,
each sensor having:
at least two spaced apart electrically conductive electrodes with at least a portion thereof embedded in the insulative material;
at least one contact for electronic communications with the meter;
a fluid sample receiving portion; and,
one or more substances on at least one of the electrodes to change the electrical properties between the electrodes upon reacting with the fluid sample.

2. The electrochemical device of claim 1 wherein the electrodes are substantially molded into the insulative material of the carrier.

3. The electrochemical device of claim 1 wherein the carrier is a substantially circular disc.

4. The electrochemical device of claim 1 wherein the electronic meter moving the device is by rotating the carrier.

5. The electrochemical device of claim 1 wherein the plurality of sensors are fixed within the carrier and not removable from the carrier.

6. The electrochemical device of claim 1 wherein the sensors are radially spaced from one another spoking outwardly from positions adjacent the center of the disc.

7. The electrochemical device of claim 1 wherein the fluid sample receiving portion is a capillary inlet adapted to draw the fluid sample into the sensor upon contact with the fluid sample, the plurality of inlets being along or adjacent a periphery of the disc.

8. The electrochemical device of claim 1 wherein the electrodes are one of either conductive wires or formed from a conductive plate.

9. The electrochemical device of claim 8 wherein the electrodes formed from a conductive plate are stamped into a specific pattern.

10. The electrochemical device of claim 1 wherein at least one electrode is coated with a conductive material different than the composition of the electrode.

11. The electrochemical device of claim 1 further including
means for detecting when a sufficient amount of the fluid sample has been received by the device selected from the group consisting of an electrical indication and a visual indication.

12. The electrochemical device of claim 11 wherein the means for detecting when a sufficient amount of fluid sample has been received includes a depressurization vent formed in the sensor, in communication with a reaction zone, and allowing for fill detection to be made visually.

13. The electrochemical device of claim 12 wherein the reaction zone is in communication with a capillary inlet.

14. The electrochemical device of claim 11 wherein the means for detecting when a sufficient amount of fluid sample has been received includes a reaction zone in communication with a capillary inlet, the reaction zone having an interior surface and at least a portion of the at least two electrodes exposed therein for contacting the fluid sample drawn therein to activate the meter to indicate sufficient fill.

15. The electrochemical device of claim 11 wherein the means for detecting when a sufficient amount of fluid sample has been received includes a cavity forming a reaction zone in the sensor, the reaction zone having at least a portion of the at least two electrodes exposed therein for contacting the fluid sample drawn therein to activate the meter to indicate sufficient fill.

16. An electrochemical device for cooperating with an electronic meter capable of holding the device, moving the device and measuring electrical properties between at least two electrically conductive electrodes, comprising:
a carrier of molded insulative material supporting a plurality of electronic sensors thereon,
each sensor having:
at least two pieces, a body and an end cap, attachable to one another;
at least two spaced apart electrically conductive electrodes with at least a portion thereof embedded in the insulative material;
at least one contact for electronically communicating with the meter;
means for receiving a fluid sample; and,
one or more substances on at least one of the electrodes to change the electrical properties between the electrodes upon reacting with the fluid sample.

17. An electrochemical device for cooperating with an electronic meter capable of holding the device, moving the device and measuring electrical properties between at least two electrically conductive electrodes, comprising:
a carrier of molded insulative material supporting a plurality of electronic sensors thereon,
each sensor having:
a body having a hinge constructed therein for permitting the pivoting and connecting of a portion of the body onto itself;
at least two spaced apart electrically conductive electrodes with at least a portion thereof embedded in the insulative material;
ate least one contact for electronically communicating with the meter;
a fluid sample receiving portion; and,
one or more substances on at least one of the electrodes to change the electrical properties between the electrodes upon reacting with the fluid sample.
